(19) United States
(12) Patent Application Publication
(10) Pub. No.: US 2019/0303430 A1
(43) Pub. Date: Oct. 3, 2019

(54) SYSTEMS AND METHODS FOR DYNAMICALLY BUILDING ONLINE INTERACTIVE FORMS

(71) Applicant: Seven Thirds, Inc., St. Peters, MO (US)

(72) Inventors: Brandon R. Cockerham, St. Peters, MO (US); Jeffrey C. Kitsmiller, JR., St. Peters, MO (US); Dustin R. Sanders, St. Peters, MO (US)

(21) Appl. No.: 16/370,410

(22) Filed: Mar. 29, 2019

Related U.S. Application Data
(60) Provisional application No. 62/649,865, filed on Mar. 29, 2018.

(51) Int. Cl. G06F 17/24; G06F 3/0481; G06F 3/0482; G06F 3/0484

(52) U.S. Cl. CPC G06F 17/243; G06F 3/04817; G06F 3/04847; G06F 3/04842; G06F 3/0482

(57) ABSTRACT

A form builder computer device for dynamically generating online forms is provided. The form builder computer device including at least one memory and at least one processor in communication with the at least one memory. The at least one processor is programmed to receive a plurality of text input from a user, receive a field indicator for a form component type from the user, and display the plurality of text inline with a copy of a form component associated with the form component type.

### CROSS-REFERENCE TO RELATED APPLICATIONS

This application claims the benefit of priority to U.S. Provisional Patent Application No. 62/649,865, filed Mar. 29, 2018, the entire contents and disclosure of which are hereby incorporated by reference in their entirety.

### BACKGROUND

The field of the invention relates generally to dynamic form building, and more specifically to systems and methods for dynamically generating online forms based on user interaction.

In many cases, building a form for a user to fill out on a computer is a complicated and involved process. Depending on the system being used, the user may have to step through many processes and use cumbersome tools. In other cases, these tools may require training before being able to make such forms. In some cases, the forms require exact and static placement of the parts that will be user-interactive. As such, there is a need for a simplified system for dynamically building forms for users to easily fill out online.

### BRIEF DESCRIPTION

In one aspect, a form builder computer device is provided. The form builder computer device includes at least one memory and at least one processor in communication with the at least one memory. The at least one processor is programmed to receive a plurality of text from a user. The at least one processor is also programmed to receive a field indicator for a form component type from the user. The at least one processor is further programmed to determine a position for a copy of a form component associated with the form component type. In addition, the at least one processor is programmed to display the plurality of text inline with the copy of the form component.

In another aspect, a computer device is provided. The computer device includes at least one memory and at least one processor in communication with the at least one memory. The at least one processor is programmed to display a form including a plurality of text sections and a plurality of form components. Each of the plurality of form components are configured to receive user input. The plurality of form components are positioned inline with the plurality of text sections. The at least one processor is also programmed to receive a user input for a component of the plurality of form components. The at least one processor is further programmed to adjust a size of the component based on the user input. In addition, the at least one processor is programmed to adjust a position of one or more sections of text of the plurality of text sections and one or more components of the plurality of form components based on the adjusted size of the component.

In a further aspect, a method for building a form is provided. The method is implemented by a computer device including at least one processor in communication with at least one memory device. The method includes receiving a plurality of text from a user, receiving a field indicator for a form component type from the user, determining a position for a copy of a form component associated with the form component type, and displaying the plurality of text inline with the copy of the form component.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a system for a dynamic form builder in accordance with one embodiment of the disclosure.

FIG. 2 illustrates a view of a user interface in edit mode of a form builder using the system shown in FIG. 1 in accordance with one embodiment of the disclosure.

FIG. 3 illustrates another view of the user interface in edit mode shown in FIG. 2 in accordance with one embodiment of the disclosure.

FIG. 4 illustrates a view of the toolbar shown in FIG. 2 in accordance with one embodiment of the disclosure.

FIG. 5 illustrates a simplified block diagram of an exemplary form builder system for dynamically generating online forms based on user interaction.

FIG. 6 illustrates an exemplary configuration of a client computer device as shown in FIG. 5, in accordance with one embodiment of the present disclosure.

FIG. 7 illustrates an exemplary configuration of a server system as shown in FIG. 5, in accordance with one embodiment of the present disclosure.

FIG. 8 illustrates a view of the user interface in use mode in accordance with one embodiment of the disclosure.

FIG. 9 illustrates a view of the user interface in use mode where the user has added a code snippet to the form.

FIG. 10 illustrates a view of the user interface in use mode where the user has added a plurality of images to the form.

### DETAILED DESCRIPTION

The present embodiments may relate to, inter alia, systems, methods, computer programs, and computer networks for dynamically generating online forms based on user interaction. In one exemplary embodiment, the methods may be performed by a form builder (“FB”) computer device.

In the exemplary embodiment, the FB computer device (also known as the FB server) allows a form creator to generate a form. The form consists of form text and components to be filled out. For the purposes of this application, the term “form text” refers to the textual information on a form that is not designated as editable by the end user, for example textual information that instructs the user on what to fill in on the form.

Once the form is complete, the FB computer device saves the form in a storage memory, such as, but not limited to, a database, a data store, or any other data storage structure that allows the FB computer device to perform as described herein. A form user may then access that saved form. When the form user accesses the form, the form user may enter data into the components based on the component type, but generally the form user does not have access to edit the form text or change any of the components of the completed form. In some situations, the user may have permissions, such as admin level permissions, that allow the user to make modifications than other users, with different permissions, would not have access to edit the form text or change any of the components.

When completed, the form user saves the filled out form. In some embodiments, the FB computer device saves the data entered in the components in a completed form. In other embodiments, the FB computer device saves the data entered in the components in a separate file from the form itself. In some further embodiments, the FB computer device tags the data that it saves so that the data may later be used for analytics. In the exemplary embodiment, the forms that are generated may be saved to be used as templates for generating other forms. If a form is created from a template, the components will retain their tags for analytical purposes.

In the exemplary embodiment, the FB computer device displays a first user interface mode (edit mode) to the form creator and a second user interface mode (use mode) to the form users. Each user interface includes different functionality available to the associated user. In addition, there is a third user interface mode (view mode) which allows a user to view the completed form, but does not allow the user to make any changes.

In the exemplary embodiment, a free-form form builder is described. The form builder may be an independent application or in some embodiments the form builder may be a component of another program, such as, but not limited to, a document creation program, an enterprise management system, and any other program or service than needs dynamic form creation. In the exemplary embodiment, the form creator may freely type and format their document. Furthermore, the documents are configured so that the components are added inline with the form text and thus the components are not forced into a specialty section of the document or form.

In one embodiment, the form builder is stored as JSON (JavaScript Object Notation). In this embodiment, the components may also be stored as strings. The state of each component is stored inline in the JSON payload of the document. Each node has a type. The user-interface is able to render the components based on the associated type, (i.e., text input, select field, etc.).

In the exemplary embodiment, components automatically resize based on the data that they display. These components resize so that the supporting form text can be completely inline. If the component does not have a value, then it sizes based off the placeholder text defined by the form creator. The form text that appears after the component shifts as the size of the component changes. Other components may also shift if they are positioned to the right of or below the component that is changing size.

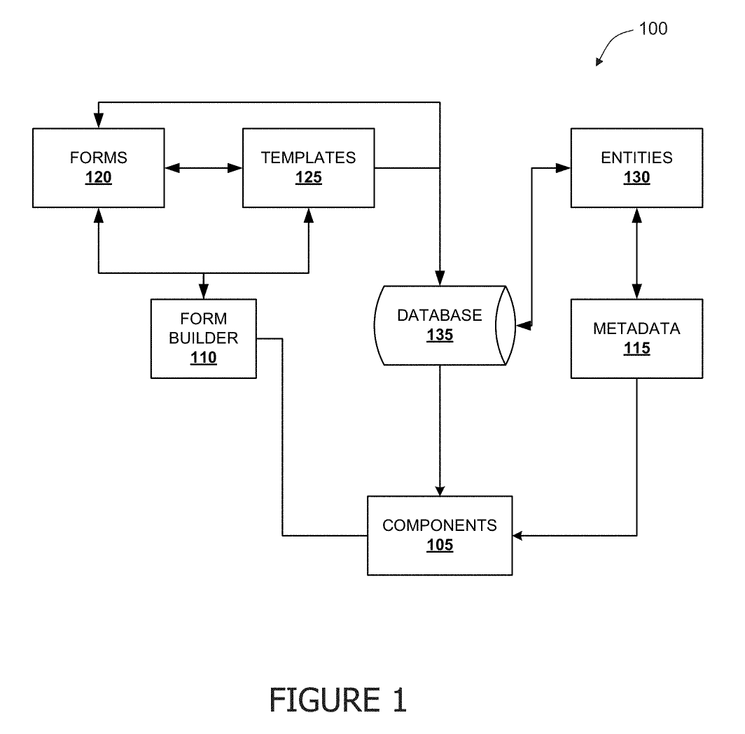

FIG. 1 illustrates data flow diagram of a system 100 for a dynamic form builder 110 in accordance with one embodiment of the disclosure. The system 100 for building forms 120 is executed by the FB computer device and/or one or more user computer devices. In the exemplary embodiment, the dynamic form builder 110 uses components 105 (such as, but not limited to, radio buttons, text input, dropdowns, date pickers, and time pickers) to generate forms 120. Form builder 110 may also use the forms 120 and components 105 to generate templates 125 that may be used to quickly generate other forms 120. In the exemplary embodiment, the forms 120 and templates 125 may be stored in a database 135. In some embodiments, database 135 represents a storage memory, such as, but not limited to, a database, a data store, or any other data storage structure that allows the system 100 to perform as described herein.

Components 105 may also have metadata 115, such as component type, when the component was added, and lists for dropdowns. Some of the metadata 115 use or refer to entities 130, which are persistent data and which may be stored in the database 135. One example may be the states or provinces in a country. In some embodiments, each state may be stored as an individual entity 130. In other embodiments, the entire list of states for the United States of America may be stored as an individual entity. A component 105, such as a dropdown component, may be configured to refer to the list of states to allow a form user to select one or more of the states from the list. In some other embodiments, the dropdown component also allows the user to multi-select multiple entries on the drop down list.

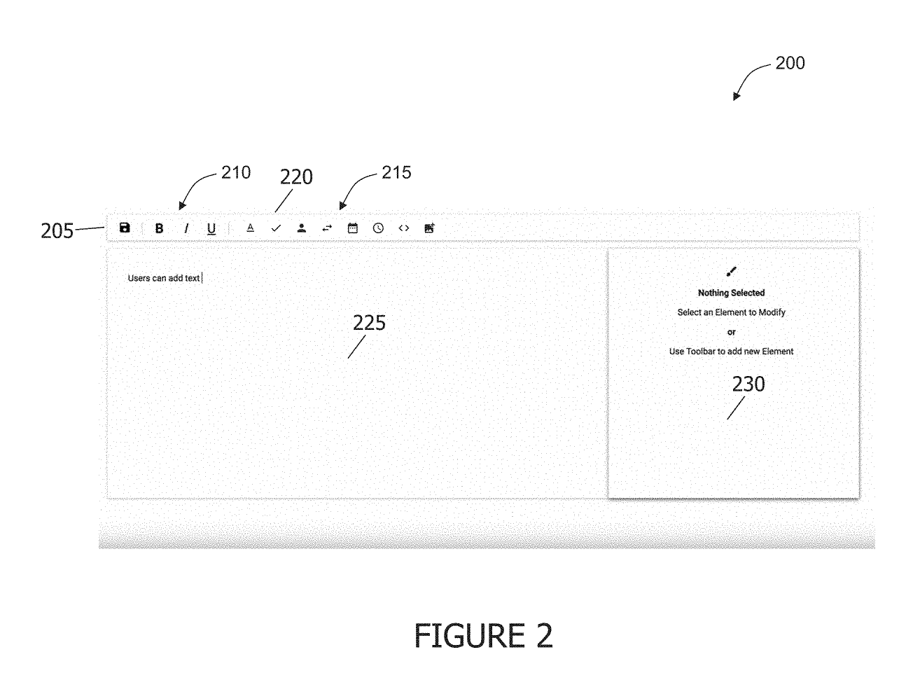

FIG. 2 illustrates a view 200 of a user interface in edit mode of a form builder using the system 100 shown in FIG. 1 in accordance with one embodiment of the disclosure. In some embodiments, view 200 is displayed on a user computer device. In some further embodiments, the FB computer device transmits instructions to the user computer device to display the user interface. In other embodiments, FB computer device displays the user interface on an associated display.

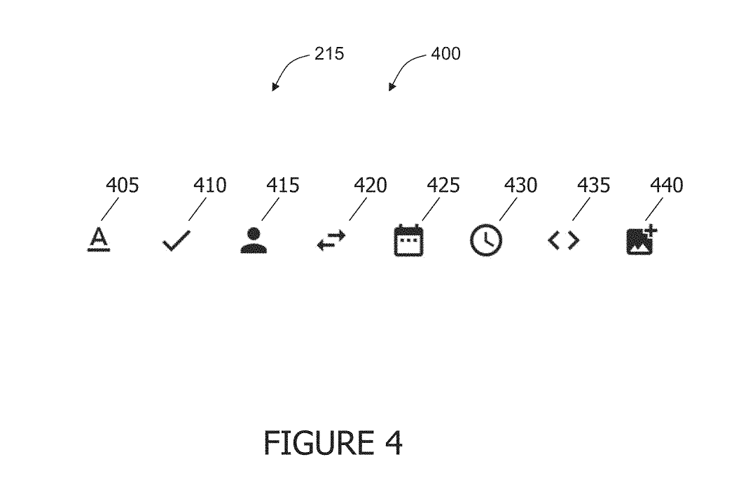

In the exemplary embodiment, view 200 displays a user-interface for editing a form. In this embodiment, view 200 displays a tool bar 205 with a plurality of icons 220 that allow the form creator to take different actions. In the exemplary embodiment, the tool bar 205 includes a data editing tool bar 210 and a component tool bar 215. The data editing tool bar 210 includes icons 220 for assisting the form creator in editing data, for example text. Example icons 220 include, but are not limited to, save, bold, italics and underline. Ones skilled in the art would understand that any data editing function could be associated with an icon 220 in data editing tool bar 210. In some embodiments, the form creator selects the icons 220 to be displayed in the data editing tool bar 210. These selections may be stored in a user profile stored in the database 135 shown in FIG. 1. The component tool bar 215 includes a plurality of icons 220 for different component types. The component tool bar 215 is also shown in FIG. 4.

The user interface also includes an editable area 225, where the form creator may enter form text and components to build the form. In the exemplary embodiment, the user interface also includes a component configuration box 230 for configuring a selected component.

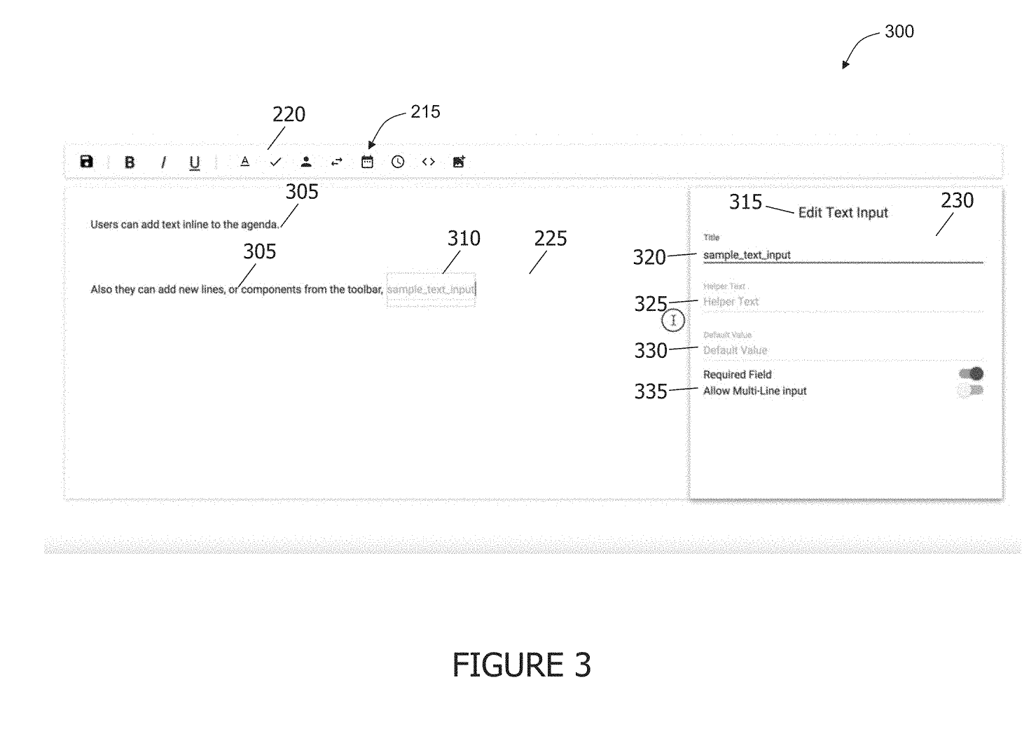

FIG. 3 illustrates another view 300 of the user interface in edit mode shown in FIG. 2 in accordance with one embodiment of the disclosure.

In this view 300, a form creator has entered form text 305 and a component 310. In the exemplary embodiment, the form creator enters form text 305 into the editable area 225 by typing or pasting. The form creator clicks an icon 220 for a component from the component tool bar 215. The FB computer device determines which icon 220 was selected and enters a component 310 of the selected type inline with the form text 305 that the form creator was entering. In the exemplary embodiment, the FB computer device places the selected component 310 where the form creator had placed the cursor. In building a form, the FB computer device is configured to place multiple components of different types in the editable area 225 interspersed with the entered form text 305.

When a component is selected, either by having the form creator clicking on the associated icon 220 or by having the form creator clicking on an existing component 310 in the editable area 225, the user interface displays the component configuration box 230 for the selected component 310. The component configuration box 230 displays information to the form creator. In this example, a text input component is shown. The component configuration box 230 displays a header 315 informing the form creator how the form creator may proceed. In this case, the header 315 informs the form creator that they may ‘Edit Text Input.’ The component configuration box 230 includes a title entry box 320, which allows the form creator to change what is displayed in the text input to assist the form user. For example, the form creator may enter “First Name” into the title entry box 320, so that a form user filling out the form will know to enter their first name in that text input component. The component configuration box 230 also includes a helper text box 325, which allows the form creator to enter helper text, which will pop up a tool tip when the form user hovers their cursor over the associated component 310. The component configuration box 230 further includes a default value box 330 for the associated text component. In addition, the component configuration box 230 also may include one or more options 335. These options 335 may be yes or no selections to allow the form creator to customize the associated component. Two example options 335 are shown in FIG. 3, whether or not the field is required to be filled in by the form user, and whether or not multiple lines of input are allowed for that component 310. Ones having skill in the art would understand that additional options 335 may be used based on the component type and the needs of the form creator.

FIG. 4 illustrates a view 400 of the toolbar 215 shown in FIG. 2 in accordance with one embodiment of the disclosure. Component toolbar 215 displays a plurality of icons 220 for different form component types. When a form creator clicks on one of these icons, the FB computer device will insert a component 305 associated with the component type of the selected icon 200. In some embodiments, the component 310 is inserted at the location of the cursor. In other embodiments, the component 310 is selected by the form creator and dragged and dropped in the desired location. In the present embodiment, the icons 220 include a text input icon 405, a select dropdown icon 410, a user select dropdown icon 415, a toggle icon 420, a date picker icon 425, a time picker icon 430, a code snippet icon 435, and an image icon 440.

The text input icon 405 is associated with a text input component, which allows a form user to enter text. This text may be short, such as a first name, or it may be long, such as a short essay answer.

The select dropdown icon 410 is associated with a select dropdown component. The select dropdown component allows a form user to select one or more options from a pre-selected list of options. In the exemplary embodiment, the select dropdown component supports both individual selections and multi-select. For example, a select dropdown component may allow a user to select a state from a list of states. The user select dropdown icon 415 is associated with a variation on the select dropdown component and allows a form user to select an individual from a list of individuals. In some embodiments, this list is set by the form creator. In other embodiments, the list is based on other data that the form user has entered into other components. In still other embodiments, the list of users may be based off of the current form users at the time of execution.

The toggle icon 420 is based on a toggle component which allows a form user to select between two options, such as yes or no. For example the toggle component may be used in a questionnaire, “Have you ever been to a foreign country.” The date picker icon 425 is associated with a date picker component. In the exemplary embodiment, the date picker component displays a calendar to allow the form user to select an individual date. The time picker icon 430 is associated with a time picker component that allows a form user to select an individual time.

The code snippet icon 435 is based on a code snippet component that allows the form user to select a portion of program code to insert into the form field. For example, this may be used in bug reporting forms. In some embodiments, the code snippets are cut and pasted into the code snippet component. In other embodiments, the code snippet icon allows the form user to open a separate file, such as a source code file, and then select the desired section of code to display in the component 310. In the exemplary embodiment, the code snippet component displays the code snippet in the original format of the code.

The image icon 440 is based on an image component that allows the form user to select one or more images to insert into the form field. In some embodiments, the image component allows the form user to open a dialog box that facilitates the form user selecting the image to insert.

In some embodiments, the form creator defines metadata fields for the FB computer device to collect.

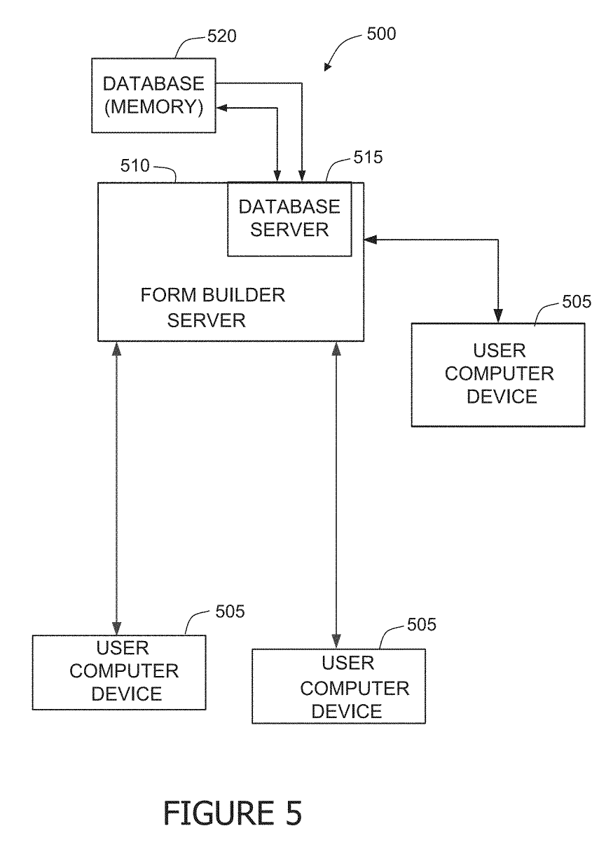

FIG. 5 depicts a simplified block diagram of an exemplary form builder (FB) computer system 500 for dynamically generating online forms based on user interaction. As described below in more detail, a form builder (“FB”) server 510 (also known as a FB computer device 510), may be configured to (i) receive a plurality of text input from a user, (ii) receive a field indicator for a form component type from the user, and (iii) display the plurality of text inline with a copy of a form component associated with the form component type as described herein.

In the exemplary embodiment, user computer devices 505 are computers that include a web browser or a software application, such as, but not limited to, an app that is downloadable from a webstore, which enables user computer devices 505 to access remote computer devices, such as FB server 510, using the Internet or other network. More specifically, user computer devices 505 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 505 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 515 is communicatively coupled to a database 520 that stores data. In one embodiment, database 520 may include saved forms, completed forms, templates, metadata, components, and component data. In the exemplary embodiment, database 520 is stored remotely from FB server 510. In some embodiments, database 520 is decentralized. In the exemplary embodiment, a user, may access database 520 via user computer device 505 by logging onto FB server 510, as described herein.

FB server 510 may be in communication with a plurality of user computer devices 505 to generate forms or allow form users to fill out existing forms. More specifically, FB server 510 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. FB server 510 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

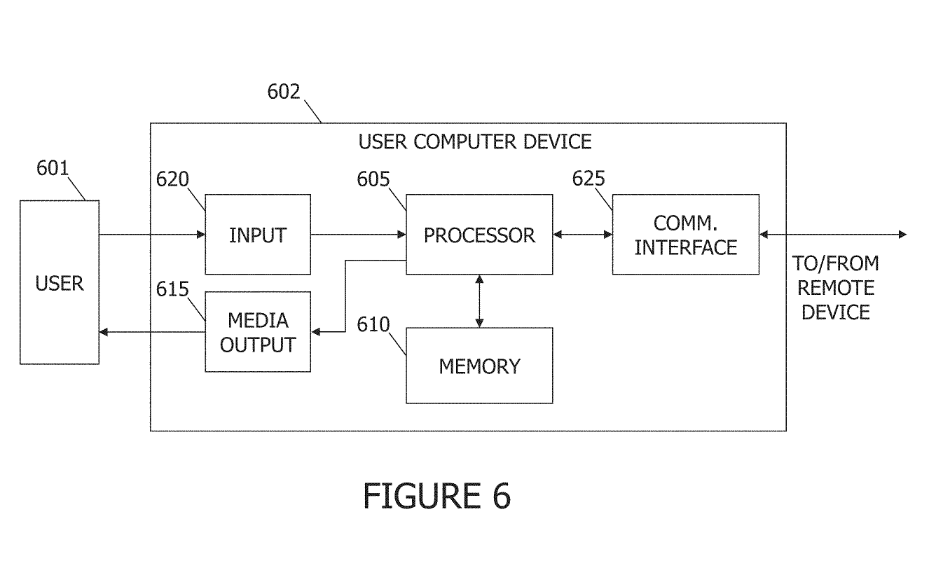

FIG. 6 depicts an exemplary configuration of client computer device, in accordance with one embodiment of the present disclosure. User computer device 602 may be operated by a user 601. User computer device 602 may include, but is not limited to, user computer devices 505 and FB server 510 (both shown in FIG. 5). User computer device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 615 may be configured to present a graphical user interface (e.g., a web browser and/or a client application) to user 601. A graphical user interface may include, for example, an interface for viewing and generating forms. In some embodiments, user computer device 602 may include an input device 620 for receiving input from user 601. User 601 may use input device 620 to, without limitation, select a component to add to the form.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as FB server 510 (shown in FIG. 5). Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from FB server 510. A client application may allow user 601 to interact with, for example, FB server 510. For example, instructions may be stored by a cloud service, and the output of the execution of the instructions sent to the media output component 615.

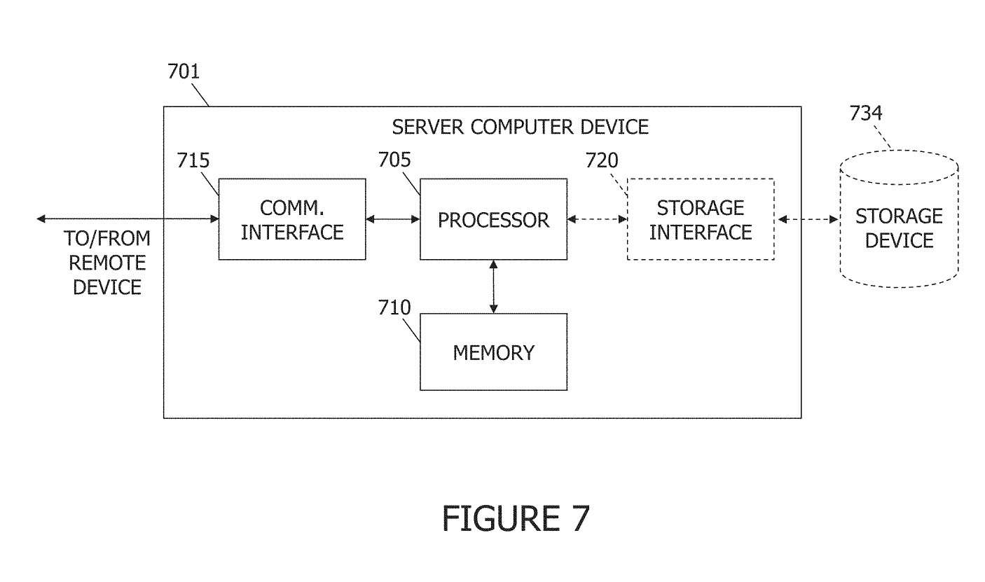

FIG. 7 depicts an exemplary configuration of server system, in accordance with one embodiment of the present disclosure. Server computer device 701 may include, but is not limited to, FB server 510 and database server 515 (both shown in FIG. 5). Server computer device 701 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 is capable of communicating with a remote device such as another server computer device 701, FB server 510 and user computer device 505 (both shown in FIG. 5) (for example, using wireless communication or data transmission over one or more radio links or digital communication channels). For example, communication interface 715 may receive requests from user computer devices 505 via the Internet, as illustrated in FIG. 5.

Processor 705 may also be operatively coupled to a storage device 734. Storage device 734 may be any computer-operated hardware suitable for storing and/or retrieving data, such as, but not limited to, data associated with database 520 (shown in FIG. 5). In some embodiments, storage device 734 may be integrated in server computer device 701. For example, server computer device 701 may include one or more hard disk drives as storage device 734.

In other embodiments, storage device 734 may be external to server computer device 701 and may be accessed by a plurality of server computer devices 701. For example, storage device 734 may include a storage area network (SAN), a network attached storage (NAS) system, and/or multiple storage units such as hard disks and/or solid state disks in a redundant array of inexpensive disks (RAID) configuration.

In some embodiments, processor 705 may be operatively coupled to storage device 734 via a storage interface 720. Storage interface 720 may be any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instructions.

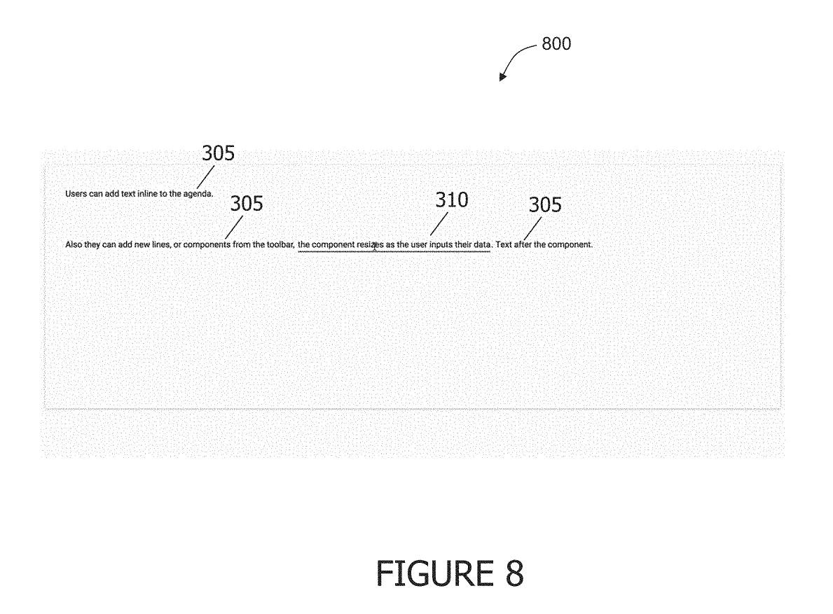

FIG. 8 illustrates a view 800 of the user interface in use mode in accordance with one embodiment of the disclosure. View 800 illustrates a form that is ready for a form user to enter data. As shown in view 800, the form includes form text 305 and a text input component 310. In view 800, data has been entered into text input component 310. In the exemplary embodiment, text input component 310 resizes to accommodate the data that has been entered. In this embodiment, the form text 305 to the right of or below the text input component 310 is shifted to make room for the data that the form user inputs into the text input component 310.

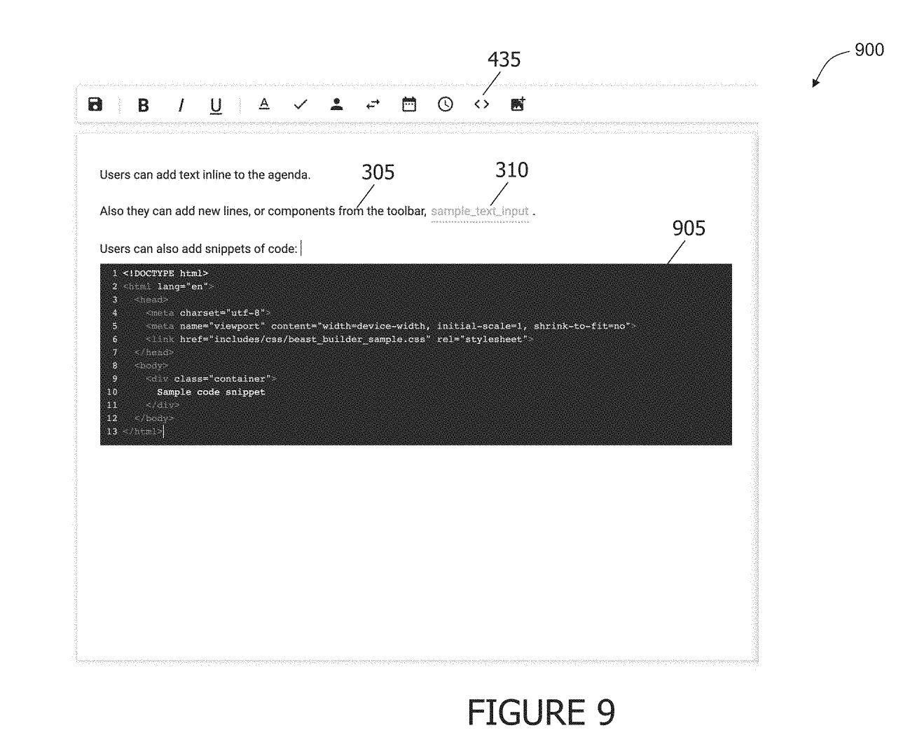

FIG. 9 illustrates a view 900 of the user interface in use mode where the user has added a code snippet to the form. View 900 illustrates a form where a form user has added a code snippet to the code snippet component 905. As shown in view 900, the form includes form text 305, a text input component 310, and a code snippet component 905. In the exemplary embodiment, code snippet component 905 resizes to accommodate the data that has been entered. If there had been form text 305 or one or more components 310 below the code snippet component 905, those items would have been shifted down to make room for the inserted code snippet.

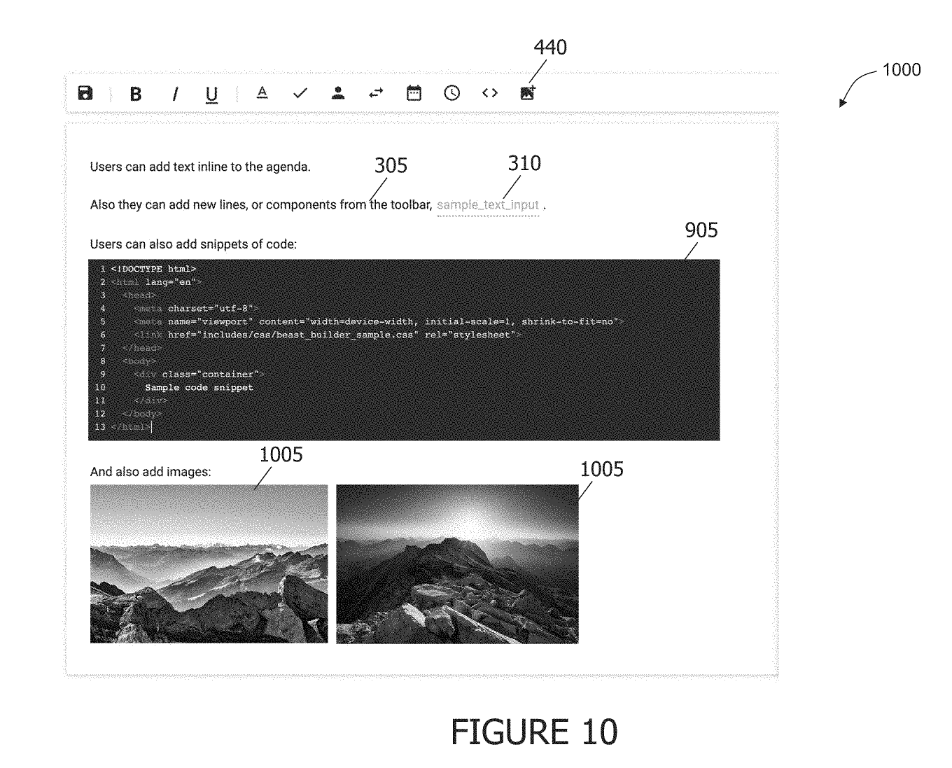

FIG. 10 illustrates a view 1000 of the user interface in use mode where the user has added a plurality of images to the form. View 1000 illustrates a form where a form user has added a code snippet to the code snippet component 905 and two images. As shown in view 1000, the form includes form text 305, a text input component 310, a code snippet component 905, and a plurality of image components 1005. In the exemplary embodiment, image components 1005 resize to accommodate the data that has been entered. If there had been form text 305 or one or more components 310 below or to the right of the image component 1005, those items would have been shifted down to make room for the inserted code snippet. In some embodiments, the form user may only add a single image to each image component 1005. In other embodiments, each image component 1005 may include multiple images.

In some embodiments, the FB computer device 510 receives a plurality of text from a user, such as form text 305 shown in FIG. 3. The FB computer device 510 then receives a field indicator for a form component type from the user, such as one of the icons 220 on the toolbar 205 (both shown in FIG. 2). The FB computer device 510 determines a position for a copy of a form component 310 (shown in FIG. 3) associated with the form component type that was just selected by the user. The FC computer device 510 displays the plurality of form text 305 inline with the copy of the form component 310.

In some embodiments, the FB computer device 510 receives one or more selections of one or more form component options from the user, such as, but not limited to, title entry box 320, helper text 325, default value 330, and options 335 (all shown in FIG. 3). In these embodiments, the FB computer device 510 displays the copy of the form component 310 based on the one or more form component options. In some embodiments, the form component type includes one of a text input component, a select dropdown component, a toggle component, a date picker component, a time picker component, a code snippet component, and an image component. In some further embodiments, the form component 310 includes one or more tags, which are used to track that specific component across the different forms that that form component 310 is used on.

In some embodiments, the FB computer device 510 saves a copy of a form including a plurality of components 310 and a plurality of form text 305. In some further embodiments, the FB computer device 510 saves a template of a form including a plurality of components 310 and a plurality of text 305.

In some further embodiments, the FB computer device 510 receives a first piece of form text 305 from the user. Then the FB computer device 510 receives a selection of a component 310 from the user. Next, the FB computer device 510 receives a second piece of form text 305 from the user. The FB computer device 510 positions the first piece of form text 305 to the left of the component 310 and the second piece of form text 305 to the right of the component 310, as shown in FIG. 8. The FB computer device 510 resizes the component 310 based on user input and repositions the second piece of form text 305 based on a size of the component.

In some embodiments, the FB computer device 510 receives a user selection of a component type. The FB computer device 510 positions the copy of the form component based on a current position of a cursor.

In some embodiments, a computer device, such as, but not limited to, a user computer device 505 (shown in FIG. 5) and the FB computer device, displays a form including a plurality of form text sections 305 and a plurality of form components 310. Each of the plurality of form components 310 are configured to receive user input. The plurality of form components 310 are positioned inline with the plurality of form text sections 305. The computer device receives a user input for a component 310 of the plurality of form components 310. The computer device adjusts a size of the component 310 based on the user input. The computer device adjusts a position of one or more sections of form text 305 of the plurality of text sections and one or more components 310 of the plurality of form components based on the adjusted size of the component 310. The one or more sections of text and the one or more components maintain relative position to the component and each other. Each component of the plurality of form components includes a default size. The computer device adjusts the size of the component 310 from the default size to the adjusted size based on the user input.

The computer device receives a selection of the form to open. The computer device displays the plurality of text sections 305 and the plurality of form components 310 in positions relative to each other. The relative positions are maintained during the user's interactions with the plurality of form components.

At least one of the technical solutions to the technical problems provided by this system may include: (i) improving the ease of use for generating forms; (ii) improving the ease of use for altering forms; (iii) simplified form management; and (iv) improved storage of form data.

The methods and systems described herein may be implemented using computer programming or engineering techniques including computer software, firmware, hardware, or any combination or subset thereof, wherein the technical effects may be achieved by performing at least one of the following steps: (a) receive a plurality of text input from a user; (b) receive a field indicator for a form component type from the user; and (c) display the plurality of text inline with a copy of a form component associated with the form component type.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing sensor data, and detecting abnormalities.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom), or any other type of operating system environment. The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A form builder computer device comprising:
at least one memory; and
at least one processor in communication with the at least one memory, the at least one processor programmed to:
receive a plurality of text from a user;
receive a field indicator for a form component type from the user;
determine a position for a copy of a form component associated with the form component type; and
display the plurality of text inline with the copy of the form component.

2. The computer device in accordance with claim 1, wherein the at least one processor is further programmed to:
receive one or more selections of one or more form component options from the user; and
display the copy of the form component based on the one or more form component options.

3. The computer device in accordance with claim 1, wherein the form component type includes one of a text input component, a select dropdown component, a toggle component, a date picker component, a time picker component, a code snippet component, and an image component.

4. The computer device in accordance with claim 1, wherein each form component includes one or more tags.

5. The computer device in accordance with claim 1, wherein the at least one processor is further programmed to save a copy of a form comprising a plurality of components and a plurality of text, wherein each of the components of the plurality of components include an ability to receive user input.

6. The computer device in accordance with claim 1, wherein the at least one processor is further programmed to save a template of a form comprising a plurality of components and a plurality of text.

7. The computer device in accordance with claim 1, wherein the at least one processor is further programmed to:
receive a first piece of text from the user;
receive a selection of a component from the user;
receive a second piece of text from the user; and
position the first piece of text to the left of the component and the second piece of text to the right of the component.

8. The computer device in accordance with claim 7, wherein the component is configured to resize based on user input, and wherein the at least one processor is further programmed to reposition the second piece of text based on a size of the component.

9. The computer device in accordance with claim 1, wherein the at least one processor is further programmed to:
receive a user selection of a component type; and
position the copy of the form component based on a current position of a cursor.

10. A computer device comprising:
at least one memory; and
at least one processor in communication with the at least one memory, the at least one processor programmed to:
display a form comprising a plurality of text sections and a plurality of form components, wherein each of the plurality of form components are configured to receive user input, and wherein the plurality of form components are positioned inline with the plurality of text sections;
receive a user input for a component of the plurality of form components;
adjust a size of the component based on the user input; and
adjust a position of one or more sections of text of the plurality of text sections and one or more components of the plurality of form components based on the adjusted size of the component.

11. A computer device in accordance with claim 10, wherein the one or more sections of text and the one or more components maintain relative position to the component and each other.

12. A computer device in accordance with claim 10, wherein each component of the plurality of form components includes a default size, and wherein the processor is programmed to adjust the size of the component from the default size to the adjusted size based on the user input.

13. A computer device in accordance with claim 10, wherein the plurality of form components includes one of a text input component, a select dropdown component, a toggle component, a date picker component, a time picker component, a code snippet component, and an image component.

14. A computer device in accordance with claim 10, wherein the at least one processor is further programmed to:
receive a selection of the form to open; and
display the plurality of text sections and the plurality of form components in positions relative to each other, wherein the relative positions are maintained during the user's interactions with the plurality of form components.

15. A method for building a form, the method implemented by a computer device comprising at least one processor in communication with at least one memory device, and wherein method comprises:
receiving a plurality of text from a user;
receiving a field indicator for a form component type from the user;
determining a position for a copy of a form component associated with the form component type; and
displaying the plurality of text inline with the copy of the form component.

16. The method in accordance with claim 15 further comprising:
receiving one or more selections of one or more form component options from the user; and
displaying the copy of the form component based on the one or more form component options.

17. The method in accordance with claim 15 further comprising saving a copy of a form comprising a plurality of components and a plurality of text, wherein each of the components of the plurality of components include an ability to receive user input.

18. The method in accordance with claim 15 further comprising:
receiving a first piece of text from the user;
receiving a selection of a component from the user;
receiving a second piece of text from the user; and
positioning the first piece of text to the left of the component and the second piece of text to the right of the component.

19. The method in accordance with claim 18, wherein the component is configured to resize based on user input, and wherein the method further comprises repositioning the second piece of text based on a size of the component.

20. The method in accordance with claim 15 further comprising:
receiving a user selection of a component type; and
positioning the copy of the form component based on a current position of a cursor.
